(19) United States
(12) Patent Application Publication
(10) Pub. No.: US 2011/0052842 A1
(43) Pub. Date: Mar. 3, 2011

(54) RECEIVING SHEET FOR DYE-SUBLIMATION HEAT TRANSFER RECORDING AND METHOD FOR MANUFACTURING THE SAME

(76) Inventors: Jin Ho Choy, Seoul (KR); Dae Hwan Park, Daejeon (KR)

(21) Appl. No.: 12/936,206

(22) PCT Filed: Apr. 23, 2010
(86) PCT No.: PCT/KR2010/002579

§ 371 Date: Oct. 1, 2010

(30) Foreign Application Priority Data
Apr. 24, 2009 (KR) 10-2009-0036149

(51) Int. Cl. B05D 5/04; B41M 5/40

(52) U.S. Cl. 428/32.5; 427/209

(57) ABSTRACT

The present invention relates to a receiving sheet for dye-sublimation thermal transfer recording and a method for manufacturing the same, and more particularly to a receiving sheet for dye-sublimation thermal transfer recording, which includes a base layer, a back coating layer formed on one surface of the base layer, and an ink-receiving layer formed on the surface opposite the surface of the base layer on which the back coating layer is formed, the ink-receiving layer containing porous metal oxide nanoparticles, and a method for manufacturing the same. The inventive receiving sheet for dye-sublimation thermal transfer recording includes the ink-receiving layer containing porous metal oxide nanoparticles. Thus, the resolution of images on the receiving sheet can be maintained, while the resistance to thermal deformation and durability of the receiving sheet can be greatly improved, thus offering many advantages in terms of image quality or cost.

### TECHNICAL FIELD

The present invention relates to a receiving sheet for dye-sublimation thermal transfer recording and a method for manufacturing the same, and more particularly to a receiving sheet for dye-sublimation thermal transfer recording, which comprises a base layer, a back coating layer formed on one surface of the base layer, and an ink-receiving layer formed on the surface opposite the surface of the base layer on which the back coating layer is formed, the ink-receiving layer containing porous metal oxide nanoparticles, and a method for manufacturing the same.

### BACKGROUND ART

As the digital camera market is rapidly expanding, the digital photograph printing field of printing digital images is greatly growing. In silver-halide photographic technology according to the prior art, photographic films are sent to a processing laboratory which will manually print the photographs. On the other hand, in digital photographic printing, desired photographs can be printed from a memory card having images stored therein, and photographic printing is possible without special limitation, wherever and whenever there is a small digital photo printer.

At this turning point of the photographic printing method, photo printing technology for printing digital photographs is receiving attention. Full-color digital printing technologies of photography level include inkjet printing, electronic photography, thermal transfer printing, and laser thermal transfer printing. Among them, the dye-sublimation thermal transfer printing technology belonging to the thermal transfer methods shows low noise during printing, high printing reliability, and a high resolution close to a natural color, and has recently been widely used in the digital photographic printing field. This printing method has been widely used to print portraits for ID cards, including identification cards, driver's licenses and membership cards.

In the thermal transfer methods, a thermal element provided in a printer transfers heat to an ink ribbon, so that a black pigment or primary color pigments coated on the ribbon are transferred to an ink-receiving sheet to form images. Such thermal transfer methods are classified into a melt thermal transfer method, which is applied for facsimile printing, label printing and the like, and the above-described dye-sublimation thermal transfer method. In the melt thermal transfer method, a pigment and binder material in an ink layer coated on an ink ribbon are simultaneously transferred to an ink-receiving sheet to form images, whereas, in the dye-sublimation thermal transfer method, only a pigment contained in an ink layer is transferred to an ink-receiving sheet to form images. The term “dye sublimation” has still been used after sublimation dyes were initially used, but this term is also called “dye diffusion” as a technical term according to the transfer mechanism.

In the melt thermal transfer method, when a polymer binder contained in an ink layer is melted by a thermal element, a pigment is transferred, and when the polymer binder is not melted, the pigment is not transferred, and thus expression ability of color gradation is decreased and a high-resolution image cannot be obtained. On the other hand, in the dye-sublimation thermal transfer method, thermal energy applied by the thermal element varies depending on the color density of a digitally input image, and the density of the pigment transferred is continuously controlled according to the amount of the energy, a high-resolution image close to a natural color can be obtained.

Dye-sublimation thermal transfer recording media consist of a color ink ribbon and an ink-receiving sheet. The ink ribbon is obtained by mixing a polymer binder with synthetic dyes, which provide primary colors of yellow, magenta and cyan, to form an ink layer on one surface of a polyester film, and coating a heat-resistant lubricating layer for preventing melt adhesion of the polyester film on the other surface of the polyester film.

An ink-receiving sheet for dye-sublimation thermal transfer recording must have the property of effectively absorbing a pigment transferred from an ink ribbon to form a full-color image and of storing the image for a long period of time. The receiving sheet is generally obtained by coating an ink-receiving layer for recording an ink pigment on a base film made of synthetic resin such as synthetic paper, polyethylene terephthalate or polyvinyl chloride, and applying a back coating for maintaining printing runnability to the other surface of the base film.

The ink-receiving layer of the receiving sheet has poor adhesion to the base film, and thus is readily detached from the base film during printing. For this reason, the technology of applying an intermediate layer serving as a primer between the base film and the ink-receiving layer was reported. Examples of the technology of applying the intermediate layer are described in U.S. Pat. No. 4,929,592, European Patent Publication No. 433,496, Japanese Patent Laid-Open No. Hei 3-67696, Korean Patent Laid-Open No. 93-16576 and the like. However, the technology of applying the intermediate layer has significant problems in terms of image resolution and image durability when it is applied to a receiving sheet for digital photographic printing which is rapidly growing.

Accordingly, the present inventors have made many efforts to develop a receiving sheet for dye-sublimation thermal transfer recording, which ensures a clear image, has no spots or wrinkles during printing and has an excellent storage property. As a result, the present inventors have found that, when porous metal oxide nanoparticles are hydrophobically modified, mixed with a binder resin and then contained in the ink-receiving layer of a receiving sheet for thermal transfer recording, the release property, image uniformity and color density of the receiving sheet are improved, thereby completing the present invention.

### SUMMARY OF INVENTION

It is an object of the present invention to provide a receiving sheet for dye-sublimation thermal transfer recording, which contains porous metal oxide nanoparticles which improve the release of the receiving sheet and improve the resolution and durability of a printed image, and a method for manufacturing the same.

To achieve the above object, in one aspect, the present invention provides a receiving sheet for dye-sublimation thermal transfer recording, which comprises: a base layer; a back coating layer formed on one surface of the base layer; and an ink-receiving layer formed on the surface opposite the surface of the base layer on which the back coating layer is formed, the ink-receiving layer containing porous inorganic nanoparticles.

In another aspect, the present invention provides a method for manufacturing a receiving sheet for dye-sublimation thermal transfer recording, the method comprising the steps of: (a) applying an ink-receiving layer containing porous metal oxide nanoparticles to one surface of a base layer; and (b) applying a back coating layer to the surface opposite the surface of the base layer to which the ink-receiving layer is applied.

Other features and embodiments of the present invention will be more apparent from the following detailed descriptions and the appended claims.

### BRIEF DESCRIPTION OF DRAWINGS

FIG. 1 shows the structure of a receiving sheet for dye-sublimation thermal transfer recording, which contains porous metal oxide nanoparticles according to the present invention.

FIG. 2 is a flowchart showing a process for preparing porous metal oxide nanoparticles according to the present invention.

### REFERENCE SIGNS LIST

5: base layer
10: back coating layer
15: intermediate coating layer
20: ink receiving layer

### DETAILED DESCRIPTION OF THE INVENTION AND PREFERRED EMBODIMENTS

In one aspect, the present invention is directed to a receiving sheet for dye-sublimation thermal transfer recording, which comprises: a base layer; a back coating layer formed on one surface of the base layer; and an ink-receiving layer formed on the surface opposite the surface of the base layer on which the back coating layer is formed, the ink-receiving layer containing porous inorganic nanoparticles.

More specifically, recently, the development of materials using nanotechnology has been conducted in a wide range of industrial fields, because the heat resistance, uniformity, light resistance and chemical resistance of nanoparticle arrays are excellent. Accordingly, in the present invention, in order to improve the heat resistance, uniformity, homogeneity, light resistance, durability and the like of a receiving sheet for dye-sublimation thermal transfer recording, porous metal oxide nanoparticles were applied to the ink-receiving layer of the receiving sheet.

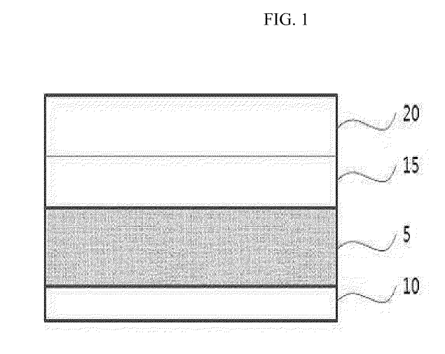

As shown in FIG. 1, the receiving sheet for dye-sublimation thermal transfer recording according to the present invention includes: a base layer 5; a back coating layer 10 formed on one surface of the base layer; and an ink-receiving layer formed on the surface opposite the surface of the base layer on which the back coating layer is formed, the ink-receiving layer 20 containing porous inorganic nanoparticles. The subject matter of the present invention is that porous metal oxide nanoparticles are contained in an ink-receiving layer 20 of a receiving sheet for dye-sublimation thermal transfer recording to improve the release and adhesion of the receiving sheet and to improve the resolution and durability of a printed image.

In the present invention, the porous metal oxide nanoparticles are preferably made of one or more selected from the group consisting of aluminum oxide, silicon dioxide, titanium oxide, zinc oxide, and alloys thereof.

In the present invention, the porous metal oxide nanoparticles have a mean particle size of 20-500 nm. If the mean particle size of the porous metal oxide nanoparticles is less than 20 nm, the nanoparticles will be difficult to use in a sufficient amount due to an increase in viscosity resulting from an increase in specific surface area when they are prepared into a solution, and if the mean particle size of the porous metal oxide nanoparticles is more than 500 nm, image uniformity can be deteriorated. For this reason, the mean particle size of the porous metal oxide nanoparticles which are contained in the receiving sheet is very important.

In the present invention, in order to improve the release of the receiving sheet during ink transfer, a plasticizer, polyethylene wax, silicone oil or the like may be added to the ink-receiving layer 20, and for the dispersion of these additives, a surfactant may also be used. In addition, the ink-receiving layer 20 may contain titanium dioxide, calcium carbonate, clay or the like in order to improve the whiteness of the receiving sheet and may contain a fluorescent dye in order to impart fluorescent. Also, the ink-receiving layer 20 may contain an antioxidant or a UV absorber in order to increase the weather resistance of the receiving sheet.

In the present invention, the coating thickness after drying of the ink-receiving layer 20 is preferably 0.5-10 μm. If the coating thickness of the ink-receiving layer is less than 0.5 μm the ink-receiving layer cannot sufficiently receive the dye transferred from a printing ribbon, and the coating thickness is more than 10 μm, it can reduce productivity and increase production cost.

In the present invention, a coating solvent for applying the ink-receiving layer 20 may be selected from the group consisting of, but not limited to, alcohol, glycol ether, ketone, toluene, dimethyl formamide, ethyl acetate, methyl ethyl ketone, and mixtures thereof, in view of solubility and workability.

In the present invention, typical examples of the binder which is added not only to the ink-receiving layer 20, but also to coating layers such as the back coating layer 10, include polyvinyl alcohols, polyvinyl pyrrolidones, celluloses such as methyl cellulose or hydroxyl propyl methyl cellulose, gelatin, polyethylene oxide, acrylic polymers, and the like. In addition, polyester polymers, polyurethane polymers or quaternary ammonium copolymers may also be used as the binder. Solvent type resins which can be used as the binder include highly polar resins, such as polyester resin, polyacrylate resin, polyvinyl acetate resin, polycarbonate resin, polyurethane resin, polyamide resin, polyvinyl chloride resin, and copolymers thereof.

In the present invention, the ink-receiving layer contains, based on 100 parts by weight of a binder, 10-30 parts by weight of porous metal oxide nanoparticles, 3-10 parts by weight of a lubricant and 3-10 parts by weight of a whitening agent. If the porous metal oxide nanoparticles are contained in an amount of less than 10 parts by weight based on 100 parts by weight of the binder, the effect thereof will be insignificant, and if the porous metal oxide nanoparticles are contained in an amount of more than 30 parts by weight, it will be difficult to prepare a coating solution due to an increase in viscosity, and uniform coating and the control of the amount of coating will be difficult. Also, if the lubricant is contained in an amount of less than 3 parts by weight based on 100 parts by weight of the binder, an ink ribbon can tear due to the sticking between the ink ribbon and the receiving sheet resulting from a decrease in the lubricating property, and an image can be spotted, and if the lubricant is contained in an amount of more than 10 parts by weight, the adhesion of a protective layer to the receiving paper during ink transfer will be insufficient to cause wrinkles on the protective layer.

Moreover, if the whitening agent is contained in the ink-receiving layer in an amount of less than 3 parts by weight based on 100 parts by weight of the binder, the whiteness of the receiving sheet will be reduced to deteriorate the appearance quality of a photograph, and if the whitening agent is contained in an amount of more than 10 parts by weight, the uniformity of coating can be reduced to reduce the gloss of the receiving sheet.

Because the ink-receiving layer 20 according to the present invention contains porous metal oxide nanoparticles, the coating of the ink-receiving layer on the receiving sheet can be uniform, the transferred from the transfer ribbon can be dispersed due to the porosity and high specific surface area of the nanoparticles and, at the same time, adsorbed to increase the uniformity of an image, and in addition, the durability and feeding properties of the receiving sheet can be improved by virtue of the properties of the nanoparticles.

In the present invention, a base layer 5 may be made of a film of polyester sulfone, polyimide, cellulose acetate, a vinyl alcohol/acetal copolymer or polyethylene terephthalate, or may be made of synthetic paper prepared from polyethylene, polypropylene or polyester. If the polypropylene synthetic paper is used as the base material, the synthetic paper itself will be readily deformed by heat. For this reason, it is preferable to use two sheets of polypropylene synthetic paper deposited on both sides of wood-free paper for dimensional stability.

In the present invention, the thickness of the base layer 5 is preferably 50-500 μm, such that the base layer can be easily handled and can be prevented from bent when a coating layer is formed thereon.

In the present invention, the back coating layer 10 is formed in order to prevent curling of a recording medium and to improve feeding or running during printing. An inorganic material which can be used in the back coating layer may be selected from the group consisting of silica, alumina, calcium carbonate, kaolin, talc, calcium sulfate, barium sulfate, titanium oxide, zinc oxide, zinc carbonate, aluminum silicate, silicic acid, sodium silicate and calcium silicate. Preferably, silica may be used.

In the present invention, the back coating layer may contain, based on 100 parts by weight of a binder, 40-60 parts by weight of an inorganic material selected from the group consisting of silica, alumina, calcium carbonate, kaolin, talc, calcium sulfate, barium sulfate, titanium oxide, zinc oxide, zinc carbonate, aluminum silicate, silicic acid, sodium silicate and calcium silicate.

In the present invention, the thickness of the back coating layer 10 is preferably 0.1-5 μm. If the thickness of the back coating layer is less than 0.1 μm, the touchup property will be deteriorated, and if the thickness is more than 5 μm, the production cost will be increased.

In the present invention, an intermediate coating layer 15 may further be formed between the base layer 5 and the ink-receiving layer 20 in order to improve the adhesion therebetween. A UV blocker, an antioxidant or the like may be added to a coating solution for the intermediate coating layer to improve the light resistance of the base material, thus improving the light resistance of the receiving sheet for recording.

Also, a whitening agent or dye is generally added to an ink-receiving layer in order to increase the whiteness of a receiving sheet for recording. However, these additives will cause the yellowing of a printing section and a non-printing section. In the present invention, because such a whitening agent or dye is added to the intermediate coating layer 15 other than the ink-receiving layer, the influence of an external environment can be reduced, thus improving the light resistance of the receiving sheet.

In the present invention, examples of resin which can be used in the intermediate coating layer 15 include polyol resin, polyurethane resin, acrylic resin, vinyl resin and the like, and these resins are used together with a curing agent such as polyisocyanate. The intermediate coating layer may be made of a film of polyolefin such as polypropylene or polyethylene or a polyethylene terephthalate film. The thickness of the intermediate coating layer is preferably 0.1-5 μm, and more preferably 0.5-2 μm.

In another aspect, the present invention is directed to a method for manufacturing a receiving sheet for dye-sublimation thermal transfer recording, the method comprising the steps of: (a) applying an ink-receiving layer containing porous metal oxide nanoparticles to one surface of a base layer; and (b) applying a back coating layer to the surface opposite the surface of the base layer to which the ink-receiving layer is applied.

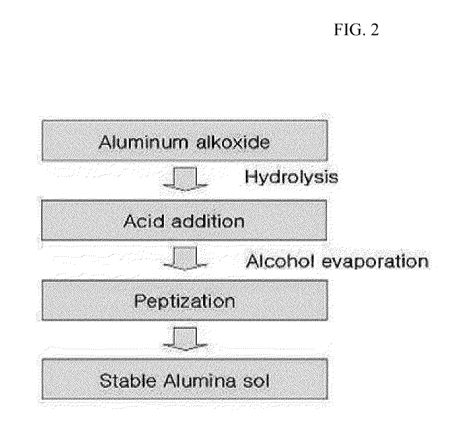

A method for manufacturing the receiving sheet for dye-sublimation thermal transfer recording according to the present invention will now be described. As shown in FIG. 2, in order to prepare porous metal oxide nanoparticles which are to be contained in the ink-receiving layer, a metal alkoxide precursor is hydrolyzed with water to obtain a gel-type mixture. An acid is added to the mixture, which is then subjected to peptization to obtain a sol-type metal oxide nanoparticle solution. The obtained solution is centrifuged to yield porous metal oxide nanoparticles having a suitable particle size. In the above-described hydrolytic reaction, the reaction temperature and the reaction time can be controlled to control the particle size of the metal oxide nanoparticles, and in the peptization, the pore size of the formed nanosol can be controlled.

The porous metal oxide nanoparticles prepared as described above are modified with a hydrophobic organic substituent before use. The hydrophobic organic substituent is changed to hydrophobicity by the hydrophobic chain thereof, so that it is easily mixed with various organic compounds, particularly binder polymers.

In the present invention, the hydrophobic organic substituent is preferably selected from the group consisting of quaternary ammonium compounds such as benzyltrimethylammonium chloride or dimethyldioctadecylammonium chloride, quaternary phosphonium compounds, and mixtures thereof. Any hydrophobic organic substituent may be used without any particular limitation in the present invention, as long as it can hydrophobically modify the porous metal oxide nanoparticles.

The porous metal oxide nanoparticles modified in the above-mentioned method is contained in a coating solution of the ink-receiving layer so as to be formed on one surface of the base layer, and then a coating solution of a back coating layer is coated on the surface opposite the surface of the base layer to which the ink-receiving layer is formed, thereby manufacturing a receiving sheet for dye-sublimation thermal transfer recording.

Examples of coating techniques which can be used in the present invention include bar coating, gravure coating, comma coating, knife coating, roll coating, etc.

Hereinafter, the present invention will be described in further detail with reference to examples.

It will be obvious to a person having ordinary skill in the art that these embodiments are merely for illustrative purposes, and the scope of the present invention should not be construed as being limited to the above described embodiments.

### Example 1

### Manufacture of Receiving Sheet for Thermal Transfer Recording Containing Porous Metal Oxide Nanoparticles

1-1: Preparation of Porous Metal Oxide Nanoparticles

5 wt % of aluminum isopropoxide (Al[OCH(CH₃)₂], 95%) was mixed with 95 wt % of water, and then hydrolyzed at 50° C. for hours, and the gel-type solution produced by the hydrolysis was subjected to hydrothermal synthesis at 95° C. for 48 hours. A small amount of acetic acid was added to the hydrothermally synthesized mixture, which was then subjected to peptization at 80° C. for 12 hours, thus preparing a metal oxide nanoparticle solution. The prepared metal oxide nanoparticle solution was centrifuged to obtain porous metal oxide nanoparticles.

1-2: Preparation of Hydrophobically Modified Porous Metal Oxide Nanoparticles

9 wt % of the porous metal oxide nanoparticles prepared in Example 1-1 and 1 wt % of benzyltrimethylammonium chloride (C₆H₅CH₂(CH₃)₃N⁺Cl⁻) were added to 90 wt % of water, and the mixture was stirred at room temperature for 4 hours. The stirred mixture was centrifuged, and then dried, thus preparing porous metal oxide nanoparticles having a particle size of 50 nm, a pore volume of 0.6 mg/L and a specific surface area of 240 m²/g.

1-3: Formation of Ink-Receiving Layer

Synthetic paper (Yupo Corporation, Japan) having a thickness of 60 μm was laminated on both surfaces of wood-free paper (Hansol Paper Co., Ltd., Korea) having a thickness of 80 μm by a dry lamination method to manufacture a base layer. An ink-receiving layer coating solution having the composition shown in Table 1 below and containing the porous metal oxide nanoparticles prepared in Example 1-2 was applied on one surface of the base layer by a comma coating method and dried at 105° C., thus forming a dye-sublimation ink-receiving layer having a thickness of 5 μm.

TABLE 1

| Contents | wt % |
|---|---|
| Vinylchloride-vinylacetate copolymer resin | 23 |
| (Japan, electric chemical Co., 1000A) | |
| Silicon oil (Japan, Shin-etsu Chemical KF393) | 1 |
| Whitening agent (Germany, Ciba, Ubitex-OB) | 1 |
| hydrophobically modified porous metal oxide nanoparticles | 5 |
| methylethylketone/toluene (weight ratio 1/1) | 70 |

1-4: Formation of Back Coating Layer

A back coating layer coating solution having the composition shown in Table 2 below was applied by a comma coating method to the surface opposite the surface of the base layer on which the ink-receiving layer had been formed as described in Example 1-3. The applied coating solution was dried at 105° C., thus forming a back coating layer having a thickness of 5 μm.

TABLE 2

| Contents | wt % |
|---|---|
| Vinylchloride-vinylacetate copolymer resin | 19 |
| (Japan, electric chemical Co. 1000A) | |
| silica(Korea, Oriental Chemical ML362) | 10 |
| Silicon oil (Japan, Shin-etsu Chemical KF393) | 1 |
| methylethylketone/toluene (weight ratio 1/1) | 70 |

### Comparative Example 1

### Manufacture of Plain Receiving Sheet for Thermal Transfer Recording

A receiving sheet for thermal transfer recording was manufactured in the same manner as in Example 1, except that the porous metal oxide nanoparticles were not contained in the receiving sheet.

### Comparative Example 2

### Manufacture of Receiving Sheet for Thermal Transfer Recording Containing Silica

A receiving sheet for thermal transfer recording was manufactured in the same manner as in Example 1, except that silica (ML 362, 10 μm, Oriental Chemical Industries, Korea) was used instead of the porous metal oxide nanoparticles.

### Test Example 1

### Measurement of Release Property, Image Uniformity and Color Density

Black images were printed on the receiving sheets for thermal transfer recording manufactured in Example and Comparative Examples using a dye-sublimation printer for printing photographs (CP-750, Cannon) and a color ribbon (KP-361P, Cannon). The release properties of the receiving sheets during printing, and the color density (optical density, OD) and color uniformity after printing were measured.

The release property during printing was evaluated on the following criteria by examining the shape of the printed receiving sheets and the printing ribbon: (∘): good release property; (Δ): exfoliated to cause severe noise, but not bonded; and (x): bonded. The measurement of the color uniformity was performed by measuring the optical densities (OD) of 10 printed cards at five portions (corners and a central portion) per card using a Spectroeye spectrophotometer (Macbeth, USA) and calculating the standard deviations of the optical densities. The measurement of the color density was performed by measuring the optical density (OD) of the black image using a Spectroeye spectrophotometer (Macbeth, USA).

The measurement results are shown in Table 3 below. As can be seen in Table 3, in the case of the receiving sheet manufactured to contain the porous metal oxide nanoparticles (Example 1), the release property of the receiving sheet from the ribbon was increased, and the diffusion of the dye was increased due to uniform coating and the porous nanoparticles, thus increasing the image uniformity and the color density. However, in the case of Comparative Example 2 in which inorganic particles (silica) having large particle size were used, the release property was relatively good, but the image uniformity was poor. In the case of Comparative Example 1 in which no inorganic particles were contained in the receiving sheet, the release property, the image uniformity and the color density were relatively poor.

TABLE 3

| Sort | Release property | image uniformity | Color density |
|---|---|---|---|
| Example 1 | ◯ | 0.2126 | 2.23 |
| Comparative | X | 0.2437 | 1.97 |
| Example 1 | | | |
| Comparative | Δ | 0.3089 | 2.15 |
| Example 2 | | | |

### INDUSTRIAL APPLICABILITY

As described above, the receiving sheet for dye-sublimation thermal transfer recording according to the present invention comprises the ink-receiving layer containing porous metal oxide nanoparticles. Thus, the resolution of images on the receiving sheet can be maintained, while the resistance to thermal deformation and durability of the receiving sheet can be greatly improved, thus offering many advantages in terms of image quality or cost.

Although the present invention has been described in detail with reference to the specific features, it will be apparent to those skilled in the art that this description is only for a preferred embodiment and does not limit the scope of the present invention. Thus, the substantial scope of the present invention will be defined by the appended claims and equivalents thereof.

1. A receiving sheet for dye-sublimation thermal transfer recording, which comprises: a base layer; a back coating layer formed on one surface of the base layer; and an ink-receiving layer formed on the surface opposite the surface of the base layer on which the back coating layer is formed, the ink-receiving layer containing porous inorganic nanoparticles.

2. The receiving sheet for dye-sublimation thermal transfer recording of claim 1, the ink-receiving layer contains, based on 100 parts by weight of a binder, 10-30 parts by weight of porous metal oxide nanoparticles, 3-10 parts by weight of a lubricant and 3-10 parts by weight of a whitening agent.

3. The receiving sheet for dye-sublimation thermal transfer recording of claim 1, the porous metal oxide nanoparticles are one or more selected from the group consisting of aluminum oxide, silicon dioxide, titanium oxide, zinc oxide, and alloys thereof.

4. The receiving sheet for dye-sublimation thermal transfer recording of claim 1, the porous metal oxide nanoparticles have a mean particle size of 20-500 nm.

5. The receiving sheet for dye-sublimation thermal transfer recording of claim 1, the thickness of the ink-receiving layer is 0.5-10 μm.

6. The receiving sheet for dye-sublimation thermal transfer recording of claim 1, the thickness of the back coating layer is 0.1-5 μm.

7. The receiving sheet for dye-sublimation thermal transfer recording of claim 1, the intermediate coating layer is formed between the base layer and the ink-receiving layer.

8. The receiving sheet for dye-sublimation thermal transfer recording of claim 7, the intermediate coating layer additionally contains one or more selected from the group consisting of a UV blocker, an antioxidant and a whitening agent.

9. A method for manufacturing a receiving sheet for dye-sublimation thermal transfer recording, the method comprising the steps of: (a) applying an ink-receiving layer containing porous metal oxide nanoparticles to one surface of a base layer; and (b) applying a back coating layer to the surface opposite the surface of the base layer to which the ink-receiving layer is applied.

10. The method of claim 9, the porous metal oxide nanoparticles are one or more selected from the group consisting of aluminum oxide, silicon dioxide, titanium oxide, zinc oxide, and alloys thereof.

11. The method of claim 9, the porous metal oxide nanoparticles are prepared by a hydrolysis of metal alkoxide.

12. The method of claim 9, the porous metal oxide nanoparticles are modified with hydrophobic organic substituent.

13. The method of claim 12, the hydrophobic organic substituent is selected from the group consisting of quaternary ammonium, quaternary phosphonium, and mixtures thereof.

14. The receiving sheet for dye-sublimation thermal transfer recording of claim 2, the porous metal oxide nanoparticles are one or more selected from the group consisting of aluminum oxide, silicon dioxide, titanium oxide, zinc oxide, and alloys thereof.

15. The receiving sheet for dye-sublimation thermal transfer recording of claim 2, the porous metal oxide nanoparticles have a mean particle size of 20-500 nm.
